(19) United States
(12) Patent Application Publication
(10) Pub. No.: US 2024/0291254 A1
(43) Pub. Date: Aug. 29, 2024

(54) RING CUTTING TOOL FOR LARGE CABLES

(71) Applicant: North Weijiamao Power And Coal Co., Ltd., Ordos City (CN)

(72) Inventors: Zhihong LI, Ordos City (CN); Zhiqiang XU, Ordos City (CN); Tiemiao LIU, Ordos City (CN); Baolong LI, Ordos City (CN); Bin HE, Ordos City (CN); Xu HUI, Ordos City (CN); Hailing YIN, Ordos City (CN); Yang LIU, Ordos City (CN); Yang BAI, Ordos City (CN); Desheng LI, Ordos City (CN); Le ZHANG, Ordos City (CN); Zongbo LIU, Ordos City (CN); Wei LIU, Ordos City (CN); Xiaolong DU, Ordos City (CN)

(21) Appl. No.: 18/500,079

(22) Filed: Nov. 1, 2023

(30) Foreign Application Priority Data
Feb. 27, 2023 (CN) 202310169203.2

(51) Int. Cl. H02G 1/12

(52) U.S. Cl. CPC H02G 1/1265

(57) ABSTRACT

Disclosed is a ring cutting tool for large cables including an installation component having a base and a middle support; an adjustment component at the support's bottom, the adjustment component includes an adjustment seat located at the bottom of the support, a scale component set inside the adjustment seat and a feeding component positioned inside and outside the adjustment seat; and a ring cutting component positioned at the bottom of the adjustment seat, the ring cutting component includes a drive component positioned between the base and the support, a cutting blade positioned at the bottom of the adjustment seat, and a locking component positioned inside the cutting blade. These components and the ring cutting component arrangement allow the device to automatically advance the cutting blade when cutting cable insulation, which not only reduces the cutting pressure of the device but also prevents damage to the interior of the cable.

### CROSS-REVERENCE TO RELATED APPLICATIONS

This application claims priority from Chinese patent application number 2023101692032 filed on Feb. 27, 2023; the disclosure of which is incorporated herein by reference in its entirety.

### FIELD OF THE INVENTION

The present invention relates to the technical field of cable processing. In particular, it relates to a ring cutting tool for large cables.

### BACKGROUND OF THE INVENTION

When installing or performing maintenance on power cables, it is necessary to strip the cable insulation (including insulation layer, semi-conductive layer, copper shielding layer, outer sheath, etc.), to make electrical connections in the circuit. Traditionally, cable stripping tools use tools like electric knives, hook knives, or utility knives to strip the cable insulation. However, for large cables, specialized equipment is required to remove their thicker insulation. Existing equipment for cutting cable insulation often results in uneven depth, especially when cutting through the semi-conductive layer or copper shielding layer of the cable. These layers are relatively thin and are easily penetrated during cutting, potentially damaging their internal structure. Additionally, the hardness and smooth surface of the copper shielding layer can cause instability during cutting, affecting the quality of the cut and posing safety risks.

In view of this, a ring cutting device for large cables has been designed. This device can cut insulation of varying thickness and features automatic blade advancement during cutting to reduce pressure, all while preventing damage to the cable's interior.

### SUMMARY OF THE INVENTION

This section aims to summarize some aspects of the embodiments of the present invention and to briefly describe some preferred embodiments. Simplification or omission may be made in this section, the abstract of the specification, and the title to avoid obscuring the purposes of this section, the abstract of the specification, and the title. Such simplification or omission may not be used to limit the scope of the present invention.

The present invention is made in view of the problems existing in the above and/or existing ring-cutting tools for large cables.

Therefore, the problem addressed by this invention is the uneven depth of cable insulation cutting in existing equipment, which can easily damage the interior of the cable.

To solve the technical problems as above-mentioned, the present invention provides the following solutions: a ring cutting tool for large cables, including an installation component having a base and a support positioned in the middle of the base; an adjustment component positioned at the bottom of the support, the adjustment component includes an adjustment seat located at the bottom of the support, a scale component set inside the adjustment seat and a feeding component positioned inside and outside the adjustment seat; and a ring cutting component positioned at the bottom of the adjustment seat, the ring cutting component includes a drive component positioned between the base and the support, a cutting blade positioned at the bottom of the adjustment seat, and a locking component positioned inside the cutting blade.

As a preferred embodiment of the ring cutting tool for large cables, where an upper surface of the base is longitudinally equipped with a placement groove, a bottom surface of the top of the support is equipped with a mounting block, the mounting block is securely connected to the support, and one side of the mounting block is equipped with locking bolts, and the locking bolts are threaded to match with the mounting block.

As a preferred embodiment of the ring cutting tool for large cables, where the adjustment seat is arc-shaped and has a first groove set along a curvature direction inside the adjustment seat, and there is a movable block at one end of the adjustment seat, the movable block is located inside the mounting block and slides in conjunction with the mounting block.

As a preferred embodiment of the ring cutting tool for large cables, where the scale component includes a scale plate positioned inside the adjustment seat, the scale plate is arc-shaped and has the same curvature as the adjustment seat, the scale plate slides in conjunction with the adjustment seat, and wherein the scale component further includes adjustment bolts located on one side of the adjustment seat, the adjustment bolts are threaded to match with the adjustment seat.

As a preferred embodiment of the ring cutting tool for large cables, where the feeding component includes a feeding block located inside the adjustment seat, the feeding block is arc-shaped and has the same curvature as the adjustment seat, and with a second groove set along a curvature direction, the feeding block slides conjunction with the adjustment seat, and one end of the feeding block is fixed with a rack.

As a preferred embodiment of the ring cutting tool for large cables, where the feeding component further includes a gear set inside the first groove and engaged with the rack, a worm gear coaxially positioned with the gear, a worm screw meshes with the worm gear and a dial located at one end of the worm screw; the feeding component further includes a fixed copper sheet and a sliding copper sheet located on a top surface of the end of the scale plate, the fixed copper sheet and the sliding copper sheet are in contact and engage with each other, and a spring is placed between the sliding copper sheet and the scale plate.

As a preferred embodiment of the ring cutting tool for large cables, where the drive component includes a rotary ring placed in the middle of the base, the rotary ring has saw teeth on an outer edge and slots on both sides, and one side of the rotary ring is equipped with a lever.

As a preferred embodiment of the ring cutting tool for large cables, where the drive component further includes a supporting frame installed one the rotary ring, the inner side of the supporting frame is equipped with a cylinder, the cylinder is placed inside the groove and slides in conjunction with the rotary ring, and wherein the drive component further comprises a motor set at the bottom of the supporting frame, an output end of the motor meshes with the saw teeth.

As a preferred embodiment of the ring cutting tool for large cables, where there is a top block set on top of the cutting blade, an upper surface of the top block is flush with the bottom of the adjustment seat, and there is a cavity set inside the cutting blade.

As a preferred embodiment of the ring cutting tool for large cables, where the locking component includes a stop rod set inside the cutting blade, there is a conical block at the bottom end of the stop rod, and the stop rod has external threads at one end near the conical block, and there is a rotational groove at the end far from the conical block; the locking component further comprises a trigger lever set on one side of the stop rod, the bottom of the trigger lever is equipped with a clamping column, the clamping column is set within the rotational groove, the top end of the trigger lever extends from the top block and aligns with the second groove. The locking component further includes a stop block set inside the cutting blade, the stop block is triangular, with a long side in contact and fitting with the conical block, and one corner of the stop block engages in rotational coordination with the interior of the cutting blade.

The present invention has the following advantages: the installation of components, adjustment components and the arrangement of the ring cutting component allows the device to automatically advance the cutting blade when cutting cable insulation, which not only reduces the cutting pressure of the device but also prevents damage to the interior of the cable.

### BRIEF DESCRIPTION OF THE DRAWINGS

In order to more clearly illustrate the technical solutions of the embodiments of the present invention, the following will briefly introduce the drawings needed to be used in the description of the embodiments. Obviously, the drawings in the following description are only some embodiments of the present invention. For those of ordinary skill in the art, other drawings can be obtained based on these drawings without any creative labor, in which:

FIG. 1 depicts an application scenario of the ring cutting tool for large cables;

FIG. 2 depicts a partial structural schematic of the ring cutting tool for large cables;

FIG. 3 depicts a structural schematic of the adjustment component of the ring cutting tool for large cables;

FIG. 4 depicts an internal view of the adjustment component of the ring cutting tool for large cables;

FIG. 5 depicts a structure diagram of the cutting blade in the ring cutting device for large cables;

FIG. 6 depicts a structural diagram of the internal locking component of the cutting blade in the ring cutting device for large cables;

FIG. 7 depicts a structure and a partial zoomed-in view of the stop rod in the ring cutting device for large cables;

FIG. 8 depicts a cross-sectional view of the ring cutting device for large cables;

FIG. 9 depicts an enlarged view and motion trend diagram of the structure at site “A” in FIG. 8;

FIG. 10 depicts a schematic diagram illustrating the connection between the fixed copper sheet and the sliding copper sheet with the motor in the ring cutting device for large cables; and

FIG. 11 depicts a schematic diagram illustrating the structure of the support frame in the ring cutting device for large cables.

### DETAILED DESCRIPTION

To make the above-mentioned objectives, features and advantages more easily be understood, the following detailed description of the embodiments of the present invention is provided in conjunction with the specification.

Although the following descriptions illustrate in detail in order to facilitate understanding of the present invention, it should be understood by a skilled person in the art that the present invention can also be enabled by other ways not described herein. The skilled person in the art can also implement the present invention without departing from the spirit of the present invention such that the following descriptions concerning the examples will not limit the present invention.

In addition, the expressions “an embodiment” or “an example” used herein refers to including specific features, structure and characteristics of at least one embodiment of the present invention. “According to an embodiment of the present invention” appears in the present disclosure does not necessarily mean that it refers to the same embodiment, or it does not necessarily mean that it independently or selectively contradicts with one another.

### EXAMPLES

### Example 1

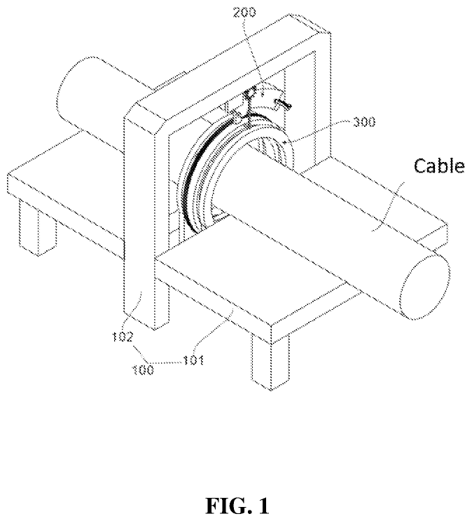

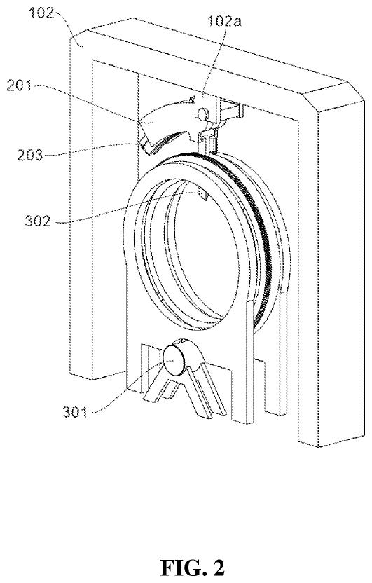

Referring to FIG. 1 and FIG. 2, which involve the first embodiment of the present invention. This embodiment provided a ring cutting tool for large cables, which included an installation component 100, an adjustment component 200 and a ring cutting component 300. The installation component 100 primarily served as the main body for the device's installation. The adjustment component 200 primarily served to regulate the depth of blade penetration. The ring cutting component 300 was responsible for circularly cutting the cable insulation.

Specifically, the installation component 100 included a base 101, a support 102 positioned in the middle of the base 101. The base 101 could be securely installed in a fixed position, or it could be equipped with swivel casters at its bottom for easy mobility. The support 102 could be welded to the base 101, mounted in the middle of the base 101, and the overall structure was square.

Preferably, the adjustment component 200 was positioned at the bottom of the support 102. The adjustment component included an adjustment seat 201 located at the bottom of the support 102, a scale component 202 set inside the adjustment seat 201 and a feeding component 203 positioned inside and outside the adjustment seat 201. The adjustment seat 201 was responsible for the blade's advancement, the scale component 202 was used to adjust the final depth of the cut, and the feeding component 203 was utilized to control the gradual and controlled advancement of the cutting blade 302.

In the preferred configuration, the ring cutting component 300 was positioned at the bottom of the adjustment seat 201. The ring cutting component included a drive component 301 positioned between the base 101 and the support 102, a cutting blade 302 positioned at the bottom of the adjustment seat 201, and a locking component 303 positioned inside the cutting blade 302. The drive component 301 primarily drove the cutting blade 302 in a circular motion. The locking component 303 could prevent the cutting blade 302 from retracting during the blade's advancement.

When used, the cable to be cut was placed on the base 101, ensuring it was positioned in the middle of the drive component 301. Then, the adjustment seat 201 was adjusted to position the cutting blade 302 with its blade edge against the cable insulation. After that, the scale component 202 was adjusted to determine the final depth of blade penetration. Then, the drive component 301 was started to drive the cutting blade 302 in a circular motion, continuously cutting the cable insulation. Through the action of the feeding component 203, the cutting blade 302 could gradually advance, cutting in a circular fashion, until it reached the pre-set depth of penetration.

### Example 2

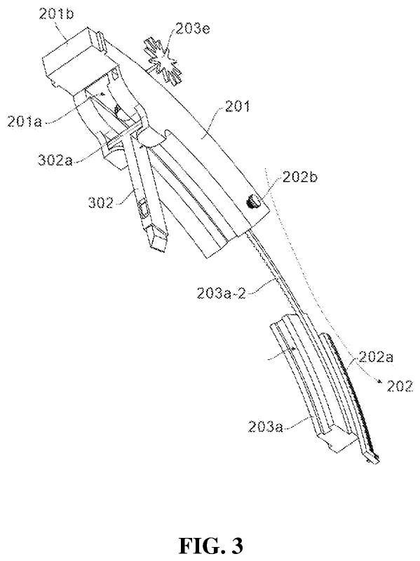

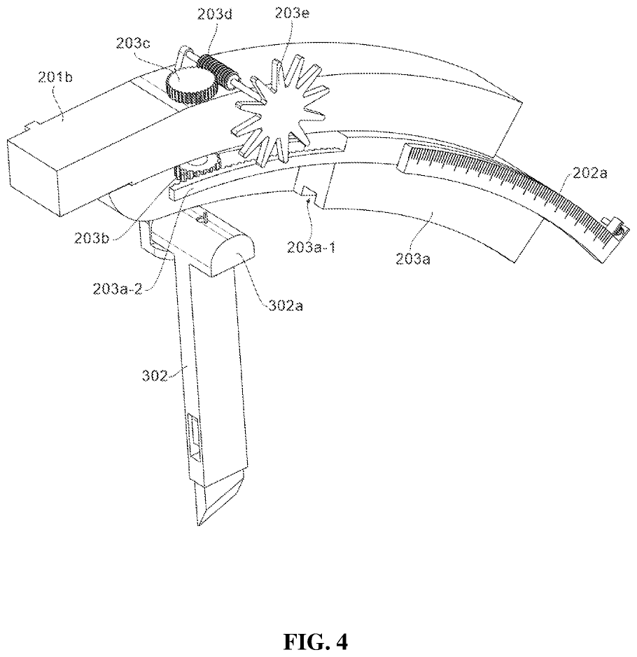

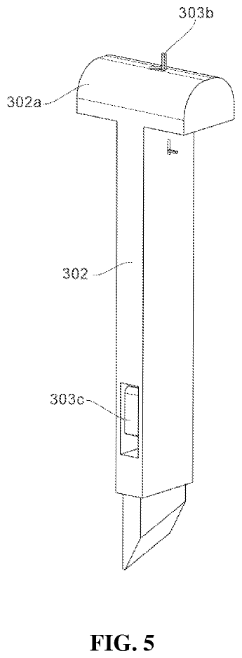

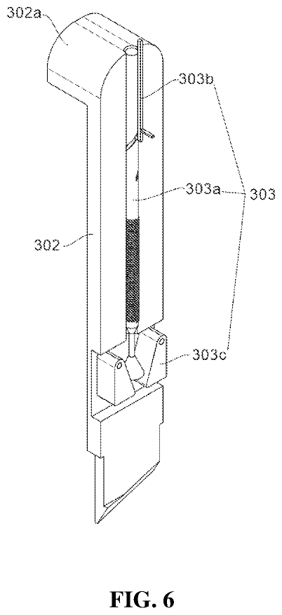

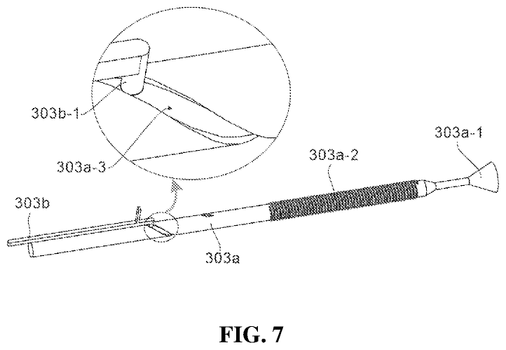

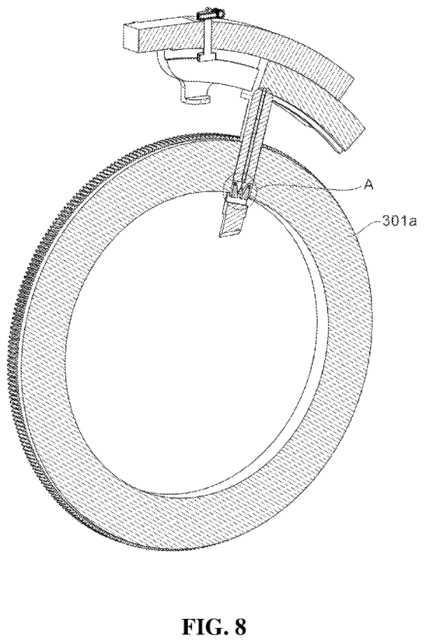

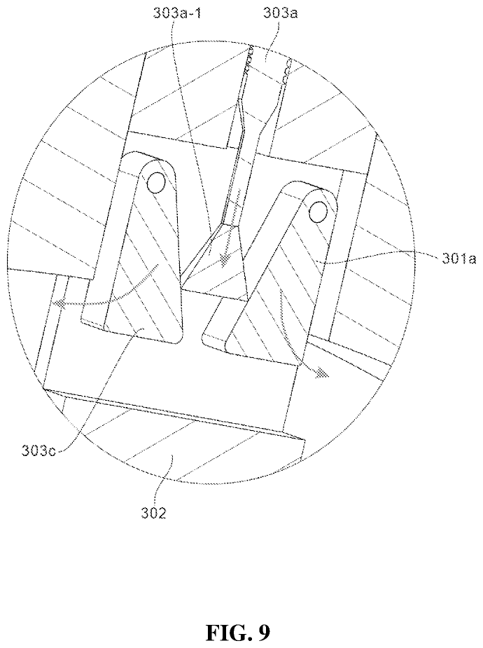

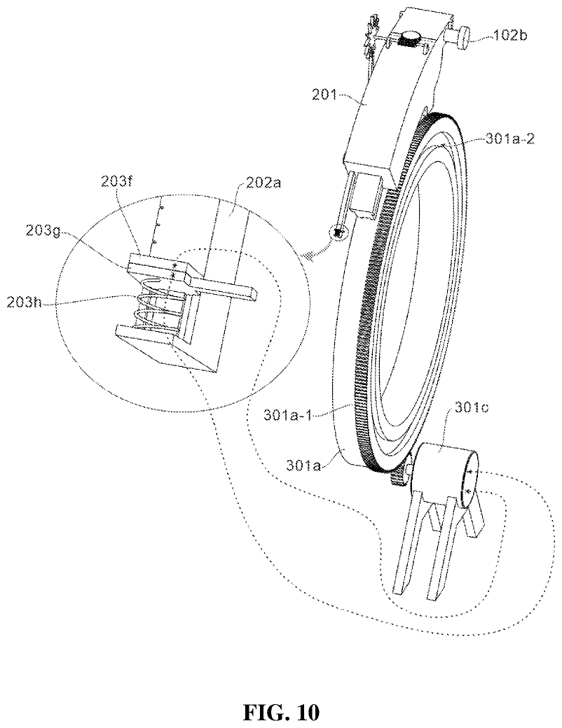

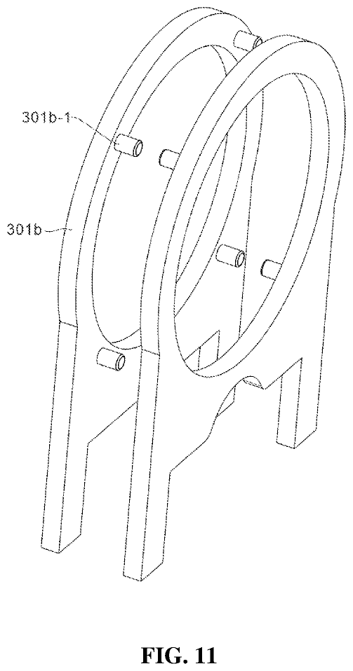

Referring to FIG. 2 to FIG. 11, which involve the second embodiment of the present invention. This embodiment was based on the previous embodiment.

Specifically, the upper surface of the base 101 had a placement groove 101a arranged in the lengthwise direction. The bottom surface of the top of the support 102 was equipped with mounting blocks 102a. The mounting blocks 102a were securely connected to the support 102. There were locking bolts 102b on one side of the mounting blocks 102a, and these locking bolts 102b were threaded to match the mounting blocks 102a. The placement groove 101a was arc-shaped, serving as concave grooves for accommodating the cables. The mounting blocks 102a was two plates welded to the support 102, and they had inner limited grooves that matched with limit protrusions on the adjustment seat 201, allowing the adjustment seat 201 to move up and down. The locking bolts 102b could secure the position of the adjustment seat 201.

Preferably, the adjustment seat 201 was arc-shaped and had a first groove 201a set along a curvature direction inside the adjustment seat 201, and there was a movable block 201b at one end of the adjustment seat 201, the movable block 201b was located inside the mounting block 102a and slide in conjunction with the mounting block 102a. The first groove 201a was a variable-diameter groove with a cross-section in a″T″shape. The moving block 201b was equipped with limit protrusions on both sides, allowing it to move up and down on the mounting block 102a. Additionally, the arc-shaped circle of the adjustment seat 201 was not concentric with the rotating ring 301a.

Preferably, the scale component 202 had a scale plate 202a positioned inside the adjustment seat 201, the scale plate 202a was arc-shaped and had the same curvature as the adjustment seat 201. The scale plate 202a slide in conjunction with the adjustment seat 201. The scale component 202 further contained adjustment bolts 202b located on one side of the adjustment seat 201, the adjustment bolts 202b were threaded to match with the adjustment seat 201. The surface of the scale plate 202a was marked with graduations to indicate the depth of blade penetration. Tightening the adjustment bolt 202b secured the scale plate 202a.

Preferably, the feeding component 203 had a feeding block 203a located inside the adjustment seat 201, the feeding block 203a was arc-shaped and had the same curvature as the adjustment seat 201, and with a second groove 203a-1 set along a curvature direction, the feeding block 203a slide conjunction with the adjustment seat 201, and one end of the feeding block 203a was fixed with a rack 203a-2. The feeding block 203a could slide within the second groove 203a-1, extending the length at the end of the adjustment seat 201. The corresponding scale on scale plate 202a represented the depth of blade penetration for cutting blade 302.

In the preferred configuration, the feeding component 203 further contained a gear 203b set inside the first groove 201a and engaged with the rack 203a-2, a worm gear 203c coaxially positioned with the gear 203b, a worm screw 203d meshes with the worm gear 203c and a dial 203e located at one end of the worm screw 203d. When the dial 203e was turned, it drove the worm screw 203d to rotate, which, in turn, drove the worm gear 203c to rotate. The worm gear 203c, through the gear 203b, then moved the rack 203a-2, thereby controlling the extension of the feeding block 203a. Since the self-locking nature of the worm gear 203c and worm screw 203d engagement, the extension length of the feeding block 203a could only be controlled using the dial 203e. In addition, the dial 203e was polygonal, and each edge's rotation angle corresponded to the graduations on the scale plate 202a.

The feeding component 203 further contained a fixed copper sheet 203f and a sliding copper sheet 203g located on a top surface of the end of the scale plate 202a, the fixed copper sheet 203f and the sliding copper sheet 203g were in contact and engaged with each other, and a spring 203h was placed between the sliding copper sheet 203f and the scale plate 202a. The fixed copper sheet 203f and the sliding copper sheet 203g were electrically connected to the motor 301c, forming a circuit between them. When the fixed copper sheet 203f and the sliding copper sheet 203g separated, the circuit was disconnected, resulting in the motor 301c losing power. Therefore, when the feeding block 203a gradually reached the end of the scale plate 202a, which was the position of the sliding copper sheet 203g, it pushed the sliding copper sheet 203g, causing it to disconnect from the fixed copper sheet 203f. This would automatically stop the motor 301c.

Preferably, the drive component 301 included a rotary ring 301a placed in the middle of the base 101, the rotary ring 301a had saw teeth 301a-1 on an outer edge and slots 301a-2 on both sides, and one side of the rotary ring was equipped with a lever 301a-3. The rotation of the rotary ring 301a would also cause the lever 301a-3 to rotate together. When the lever 301a-3 completed one full rotation, it would engage the dial 203e once, thereby moving the feeding block 203a outward slightly until it reached the end of scale plate 202a.

Preferably, the drive component 301 further included a supporting frame 301b installed one the rotary ring 301a, the inner side of the supporting frame 301b was equipped with a cylinder 301b-1, the cylinder 301b-1 was placed inside the groove 301a-2 and slide in conjunction with the rotary ring 301a. The drive component 301 further included a motor 301c set at the bottom of the supporting frame 301b, an output end of the motor 301c meshed with the saw teeth 301a-1. The supporting frame 301b and the cylinder 301b-1 primarily served to support the rotation of the rotating ring 301a. When the motor 301c rotated, it would drive the rotating ring 301a to turn as well.

Furthermore, there was a top block 302a set on top of the cutting blade 302, an upper surface of the top block 302a was flush with the bottom of the adjustment seat 201, and there was a cavity set inside the cutting blade 302. The cutting blade 302 was fixed inside the ring of the rotating ring 301a, allowing it to move only along the radial direction of the rotating ring 301a. Since the non-concentricity of the adjustment seat 201 and the rotating ring 301a, when the rotating ring 301a turned, the top block 302a on the top of the cutting blade 302 would be gradually pressed by the bottom of the adjustment seat 201, moving towards the center of the rotating ring 301a, thereby achieving blade penetration.

Furthermore, the locking component 303 included a stop rod 303a set inside the cutting blade 302, there was a conical block 303a-1 at the bottom end of the stop rod 303a, and the stop rod 303a had external threads 303a-2 at one end near the conical block 303a-1, and there was a rotational groove 303a-3 at the end far from the conical block 303a-1. The conical block 303a-1 was in the shape of an inverted cone. The stop rod 303a was threaded onto the cutting blade 302 with the external threads 303a-2. In other words, when the stop rod 303a rotated, it moved vertically.

The locking component 303 further included a trigger lever 303b set on one side of the stop rod 303a, the bottom of the trigger lever 303b was equipped with a clamping column 303b-1. The clamping column 303b-1 was set within the rotational groove 303a-3, the top end of the trigger lever 303b extended from the top block 302a and aligned with the second groove 203a-1. When the trigger lever 303b moved along the axis of the stop rod 303a, the clamping column 303b-1 would, through the rotation groove 303a-3, drive the stop rod 303a to rotate, thus achieving the movement of the stop rod 303a.

The locking component 303 further included stop block 303c set inside the cutting blade 302. The stop block 303c was triangular, with a long side in contact and fitting with the conical block 303a-1, and one corner of the stop block 303c engaged in rotational coordination with the interior of the cutting blade 302. When the stop rod 303a moved radially toward the center of the rotating ring 301a, the wide side of the conical block 303a-1 would press against the long side of the stop block 303c, causing it to rotate outward from the cutting blade 302. This action allowed the right-angle side of the stop block 303c to abut against the juncture between the cutting blade 302 and the rotating ring 301a, preventing the cutting blade 302 from moving away from the center of the rotating ring 301a.

When in use, the cable to be cut was initially placed in the placement groove 101a on the base 101 and passed through the rotating ring 301a. Then, the locking bolts 102b were loosened to adjust the position of the adjustment seat 201 within the mounting blocks 102a, ensuring that the cutting edge of the cutting blade 302 was snug against the cable insulation. Then, the length of the scale plate 202a was adjusted based on the thickness of the cable insulation, and it was secured using the adjustment bolt 202b. Then, the motor 301c was started to drive the rotating ring 301a to turn, and the cutting blade 302 rotated accordingly. The top block 302a at its top began moving along the bottom of the adjustment seat 201. Since the adjustment seat 201 was gradually moving closer to the rotating ring 301a in the lengthwise direction, the cutting blade 302 also gradually moved toward the center of the rotating ring 301a, initiating the blade penetration. Meanwhile, the trigger lever 303b also started moving toward the center of the rotating ring 301a due to the action of the bottom of the feeding block 203a in the second groove 203a-1. Its bottom clamping column 303b-1, through the rotation groove 303a-3 on the stop rod 303a, was also turned, causing the stop rod 303a to rotate. When the stop rod 303a began moving toward the center of the rotating ring 301a, the wide side of the conical block 303a-1 would press against the long side of the stop block 303c, causing it to rotate outward from the cutting blade 302. This action allowed the right-angle side of the stop block 303c to abut against the juncture between the cutting blade 302 and the rotating ring 301a, preventing the cutting blade 302 from moving away from the center of the rotating ring 301a.

Additionally, when the rotating ring 301a turned, it would also cause the lever 301a-3 to rotate together. Every time the lever 301a-3 completed one full rotation, it would engage the dial 203e once. The dial 203e would then sequentially drive the rack 203a-2 at the end of the feeding block 203a through the worm screw 203d, worm gear 203c, and gear 203b, causing the feeding block 203a to extend outward. It would elongate a bit with each full rotation until it reached the end of scale plate 202a. When it reached the end of the scale plate 202a, which was also the maximum depth of penetration, the feeding block 203a would push the sliding copper plate 203g, causing it to disconnect from the fixed copper sheet 203f. This action would automatically stop the motor 301c, achieving an automatic stop after the cutting was completed.

It is worth noting that the foregoing examples are only used for illustration of the technical solutions of the present invention and non-limiting thereto. Though reference is made to preferred examples for detailed illustration of the present invention, a skilled person in the art should understand that the technical solutions provided by the present invention can vary or be substituted by equivalents without departing from the spirit and scope of the technical solutions described herein, which should fall within the scope of the appended claims.

What is claimed is:

1. A ring cutting tool for large cables, comprising:
an installation component comprising a base and a support positioned in the middle of the base;
an adjustment component positioned at the bottom of the support, the adjustment component comprises an adjustment seat located at the bottom of the support, a scale component set inside the adjustment seat and a feeding component positioned inside and outside the adjustment seat; and
a ring cutting component positioned at the bottom of the adjustment seat, the ring cutting component comprises a drive component positioned between the base and the support, a cutting blade positioned at the bottom of the adjustment seat, and a locking component positioned inside the cutting blade.

2. The ring cutting tool for large cables of claim 1, wherein an upper surface of the base is longitudinally equipped with a placement groove, a bottom surface of the top of the support is equipped with a mounting block, the mounting block is securely connected to the support, and one side of the mounting block is equipped with locking bolts, and the locking bolts are threaded to match with the mounting block.

3. The ring cutting tool for large cables of claim 2, wherein the adjustment seat is arc-shaped and has a first groove set along a curvature direction inside the adjustment seat, and there is a movable block at one end of the adjustment seat, the movable block is located inside the mounting block and slides in conjunction with the mounting block.

4. The ring cutting tool for large cables of claim 1, wherein the scale component comprises a scale plate positioned inside the adjustment seat, the scale plate is arc-shaped and has the same curvature as the adjustment seat, the scale plate slides in conjunction with the adjustment seat, and wherein the scale component further comprises adjustment bolts located on one side of the adjustment seat, the adjustment bolts are threaded to match with the adjustment seat.

5. The ring cutting tool for large cables of claim 4, wherein the feeding component comprises a feeding block located inside the adjustment seat, the feeding block is arc-shaped and has the same curvature as the adjustment seat, and with a second groove set along a curvature direction, the feeding block slides conjunction with the adjustment seat, and one end of the feeding block is fixed with a rack.

6. The ring cutting tool for large cables of claim 5, wherein the feeding component further comprises a gear set inside the first groove and engaged with the rack, a worm gear coaxially positioned with the gear, a worm screw meshes with the worm gear and a dial located at one end of the worm screw; the feeding component further comprises a fixed copper sheet and a sliding copper sheet located on a top surface of the end of the scale plate, the fixed copper sheet and the sliding copper sheet are in contact and engage with each other, and a spring is placed between the sliding copper sheet and the scale plate.

7. The ring cutting tool for large cables of claim 1, wherein the drive component comprises a rotary ring placed in the middle of the base, the rotary ring has saw teeth on an outer edge and slots on both sides, and one side of the rotary ring is equipped with a lever.

8. The ring cutting tool for large cables of claim 7, wherein the drive component further comprises a supporting frame installed one the rotary ring, the inner side of the supporting frame is equipped with a cylinder, the cylinder is placed inside the groove and slides in conjunction with the rotary ring, and wherein the drive component further comprises a motor set at the bottom of the supporting frame, an output end of the motor meshes with the saw teeth.

9. The ring cutting tool for large cables of claim 1, wherein there is a top block set on top of the cutting blade, an upper surface of the top block is flush with the bottom of the adjustment seat, and there is a cavity set inside the cutting blade.

10. The ring cutting tool for large cables of claim 9, wherein the locking component comprises a stop rod set inside the cutting blade, there is a conical block at the bottom end of the stop rod, and the stop rod has external threads at one end near the conical block, and there is a rotational groove at the end far from the conical block; the locking component further comprises a trigger lever set on one side of the stop rod, the bottom of the trigger lever is equipped with a clamping column, the clamping column is set within the rotational groove, the top end of the trigger lever extends from the top block and aligns with the second groove; the locking component further comprises stop block set inside the cutting blade, the stop block is triangular, with a long side in contact and fitting with the conical block, and one corner of the stop block engages in rotational coordination with the interior of the cutting blade.
